(19) United States
(12) Patent Application Publication
(10) Pub. No.: US 2006/0172183 A1
(43) Pub. Date: Aug. 3, 2006

(54) Battery cover latching assembly for portable electronic device

(75) Inventors: Rui-Hao Chen, Shenzhen (CN); Peng-Jin Ge, Shenzhen (CN); Shui-Yuan Qin, Shenzhen (CN); Chia-Hua Chen, Tu-Cheng (TW); Hsiao-Hua Tu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD, Shindian City (TW)

(21) Appl. No.: 11/336,084

(22) Filed: Jan. 20, 2006

(30) Foreign Application Priority Data
Jan. 28, 2005 (CN) 200520054455.8

(51) Int. Cl. H01M 2/10

(52) U.S. Cl. 429/97; 429/100

(57) ABSTRACT

A battery cover latching assembly (80) is used in a portable electronic device (100). The portable electronic device has a housing (10) and a battery cover (20). The batter cover latching assembly includes a locking hole (24), a button (30), a latching member (40), and a button hole (172). The locking hole is defined in the battery cover. The button has a first inclined portion (362). The latching member includes a bolt portion (42) and a positioning portion (44). One end of the bolt portion is received in the locking hole. The positioning portion has a second inclined portion. The button hole is defined in the housing. The positioning portion and the button are received in the button hole, with the second inclined portion being engaged with the first inclined portion.

### BACKGROUND OF THE INVENTION

1. Field of the Invention

The present invention generally relates to battery cover latching assemblies and, more particularly, to a battery cover latching assembly for use in a portable electronic device.

2. Discussion of the Related Art

Batteries are widely used in portable electronic devices, such as personal digital assistants (PDAs), mobile phones, and so on. Conventional batteries are attachably received in housings of the electronic device, and battery covers are designed to connect with the housings to package the batteries. The batteries have to be replaced by opening the battery covers when the batteries are, e.g., damaged, dead, and/or otherwise in need of recharging or replacement.

A clasping structure or latching structure is used to engage a conventional battery cover with a housing of a portable electronic device. For example, a mobile phone marked Alcatel OT310 has a latching assembly for a battery cover. The latching assembly includes a pair of hooks at one end of the battery cover and a locking pin protruding from the other end of the battery cover. Accordingly, a pair of grooves is defined in one end portion of a backside of a housing of the mobile phone, and a locking hole is defined in the other end portion of the backside of the housing. In assembly, the hooks are firstly inserted into the grooves in the backside of the housing. Then, the battery cover is pressed downwardly to the housing until the locking pin on the battery cover is inserted into the locking hole in the backside of the housing. The battery cover is thus assembled to the housing of the mobile phone. The latching assembly is simple in structure, and the engagement between the battery cover and the housing of the mobile phone is firm too. However, during disassembly, great effort is needed to disassemble the battery cover, thereby requiring a relatively substantial force to be exerted thereon. Therefore, the battery cover is susceptible to damage. As a result, it is inconvenient for a user to replace a battery in the conventional housing of the mobile phone.

Therefore, a new battery cover latching assembly is desired in order to overcome the above-described shortcomings.

### SUMMARY OF THE INVENTION

A battery cover latching assembly for a portable electronic device is provided, which is convenient for a user to operate and which is durable.

In one embodiment thereof, a portable electronic device has a battery cover, a battery cover latching assembly, and a housing. The battery cover latching assembly includes a locking hole, a button, a latching member, and a button hole. The locking hole is defined in the battery cover. The button has a first inclined portion. The latching member includes a bolt portion and a positioning portion. One end of the bolt portion is received in the locking hole. The positioning portion has a second inclined portion. The button hole is defined in the housing. The positioning portion and the button are received in the button hole with the second inclined portion being engaged with the first inclined portion.

Other advantages and novel features of the embodiments will become more apparent from the following detailed description thereof, when taken in conjunction with the accompanying drawings.

### BRIEF DESCRIPTION OF THE DRAWINGS

Many aspects of the battery cover latching assembly can be better understood with reference to the following drawings. The components in the drawings are not necessarily to scale, the emphasis instead being placed upon clearly illustrating the principles of the present battery cover latching assembly and its potential applications. Moreover, in the drawings, like reference numerals designate corresponding parts throughout the several views.

FIG. 1 is an exploded, isometric view of a portable electronic device with a battery cover and a housing connected via a battery cover latching assembly, in accordance with a preferred embodiment;

FIG. 2 is an isometric view of the housing of FIG. 1, but viewed from another aspect;

FIG. 3 is an enlarged, isometric view of a button of the battery cover latching assembly shown in FIG. 1;

FIG. 4 is an enlarged, isometric view of a latching member of the battery cover latching assembly shown in FIG. 1;

FIG. 5 is an assembled, isometric view of the button and the latching member of the battery cover latching assembly;

FIG. 6 is an partial cross-sectional view of an assembled battery cover latching assembly, within the portable electronic device shown in FIG. 1; and

FIG. 7 is similar to FIG. 6, but viewed from another aspect.

### DETAILED DESCRIPTION OF THE EMBODIMENTS

The present battery cover latching assembly is suitable for portable electronic devices, such as mobile phones, PDAs, and so on.

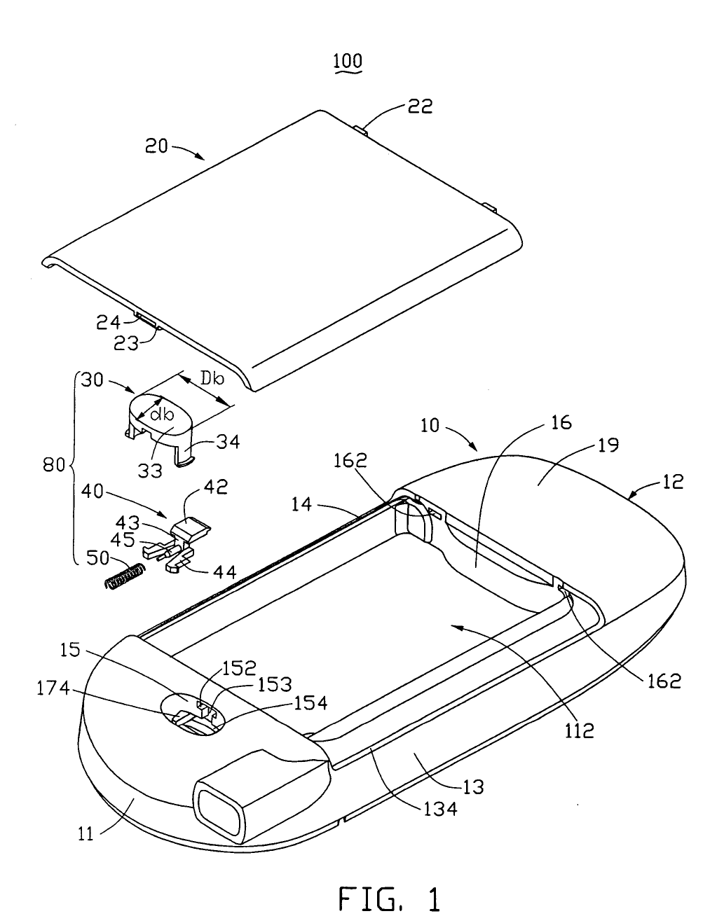

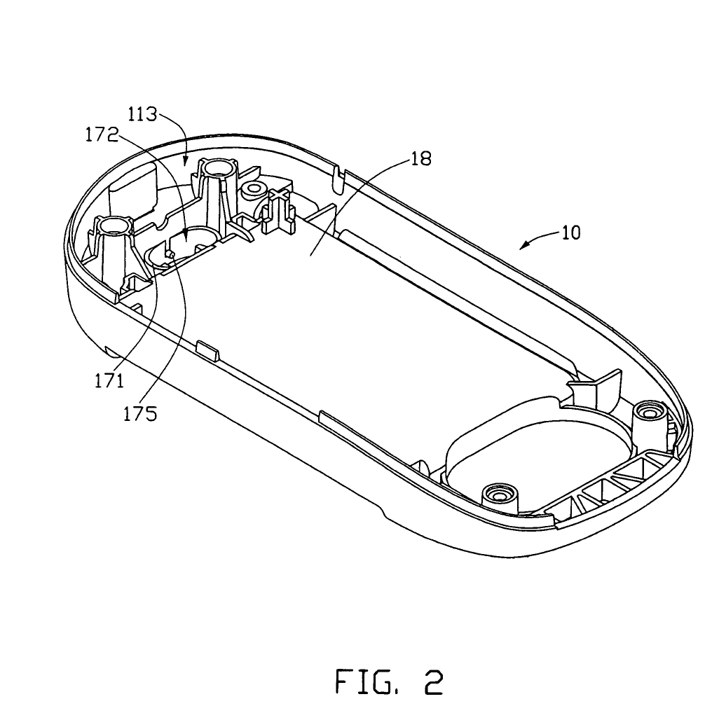

Referring now to the drawings in detail, FIG. 1 shows a battery cover latching assembly 80 for use in a mobile phone 100. The mobile phone 100 is taken here as an exemplary application, for the purposes of describing details of the battery cover latching assembly 80 of a preferred embodiment of the present assembly. The mobile phone 100 includes a housing 10 and a battery cover 20, connected via the battery cover latching assembly 80. Also referring to FIG. 2, the battery cover latching assembly 80 includes a locking hole 24, a button 30, a latching member 40, a spring 50, and a button hole 172. The locking hole 24 is defined in the battery cover 20. The button hole 172 is defined in the housing 10. The battery cover latching assembly 80 is mounted in the housing 10 and releasably locks the battery cover 20, thereby interconnecting the housing 10 and the battery cover 20.

Further referring to FIG. 2, the housing 10 includes a top wall 11, a bottom wall 12, a left sidewall 13, a right sidewall 14, a top partition wall 15, a bottom partition wall 16, a top backboard 17, an inner partition wall 18, and a bottom backboard 19, which together define an inner cavity 113. The inner cavity 113 is configured for accommodating an electronic element (not shown), such as a printed circuit board, therein, when the housing 10 is assembled with other housings of the mobile phone 100. The left sidewall 13, the right sidewall 14, the top partition wall 15, and the bottom partition wall 16 together, in turn, define an outer cavity 112 configured for accommodating a battery (not shown) therein. A pair of bottom grooves 162 is defined in the bottom partition wall 16. The bottom grooves 162 communicate with the outer cavity 112. An U-shaped groove 134 is defined in the left sidewall 13, the right sidewall 14, and the bottom partition wall 16.

A projection 171 extends from the top backboard 17, adjacent the top partition wall 15, and in the inner cavity 113. A button hole 172 is defined through the projection 171 and the top backboard 17. The combination of the top partition wall 15 and the projection 171 serves as the sidewall of the button hole 172 (FIGS. 1, 2, 6, and 7). The top partition wall 15 defines a first receiving hole 152, a second receiving hole 153, and a third receiving hole 154. The first receiving hole 152 and the third receiving hole 154 are parallel with each other. The second receiving hole 153 communicates the first receiving hole 152 and the third receiving hole 154. The three receiving holes 152, 153, and 154 communicate with the button hole 172 and the outer cavity 112. A pair of positioning tabs 174 is formed at an inner wall of the projection 171 and respectively adjacent two sides of the third receiving hole 154. A positioning pin 175 is formed at an inner wall of the projection 171 diametrically opposite the third receiving hole 154.

The battery cover 20 is substantially a rectangular board. A pair of hooks 22 is formed at one end of the battery cover 20. The two hooks 22 are engaged in the two respective bottom grooves 162 of the housing 10. A locking block 23 is formed at an opposite end of the battery cover 20. The locking block 23 has a locking hole or slot 24 therein.

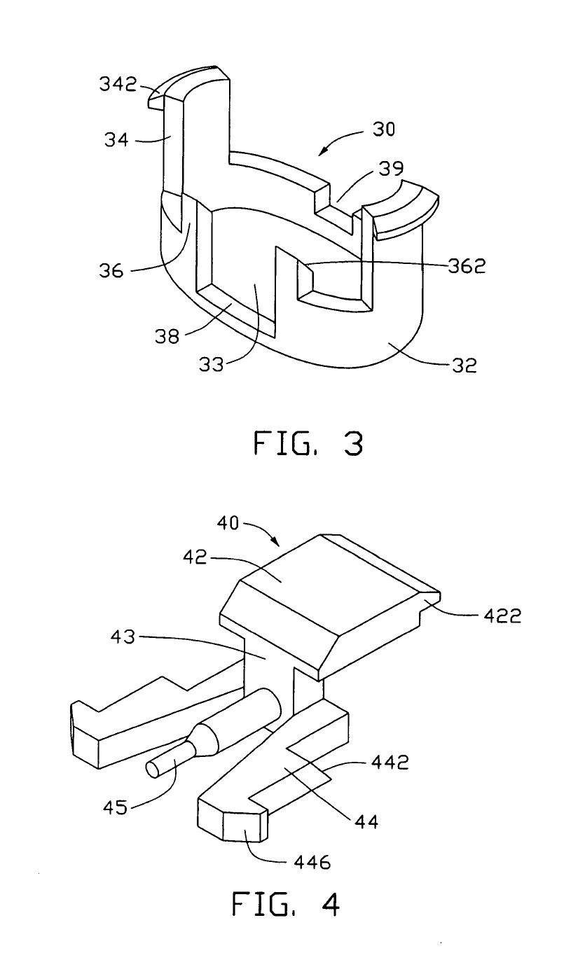

Also referring to FIG. 3, the button 30 includes an elliptical barrel portion 32 and a board 33. A first end of the barrel portion 32 is closed by the board 33. The board 33, on the side thereof opposite the barrel portion 32, further establishes the main button surface (not labeled) for pushing by a user. The button 30, being elliptical in cross-section, has a major diameter D_{b} and, orthogonal thereto, a minor diameter d_{b}. A pair of symmetrical, arcuate arms 34 extends, respectively, from the barrel portion 32 at diametrical ends of the major diameter D_{b}. The arcuate arms 34 protrude orthogonal to and away from the board 33. A pair of arcuate blocks 342 extends respectively from each distal end of the two arms 34 and in directions opposed to each other (i.e., both are directed away from the button 30). A cutout 38 and a notch 39 are respectively defined in two diametrically opposite sides, relative to the minor diameter d_{b}, of the barrel portion 32. A pair of posts 36 is formed in the barrel portion 32, respectively adjacent two sides of the cutout 38. Each post 36, similar to the arcuate arms 34, protrudes orthogonal to and away from the board 33. Each distal end of the posts 36 has an inclined surface 362. Each inclined surface 362 generally faces the interior of the barrel portion 32 and slopes inwardly toward the board 33.

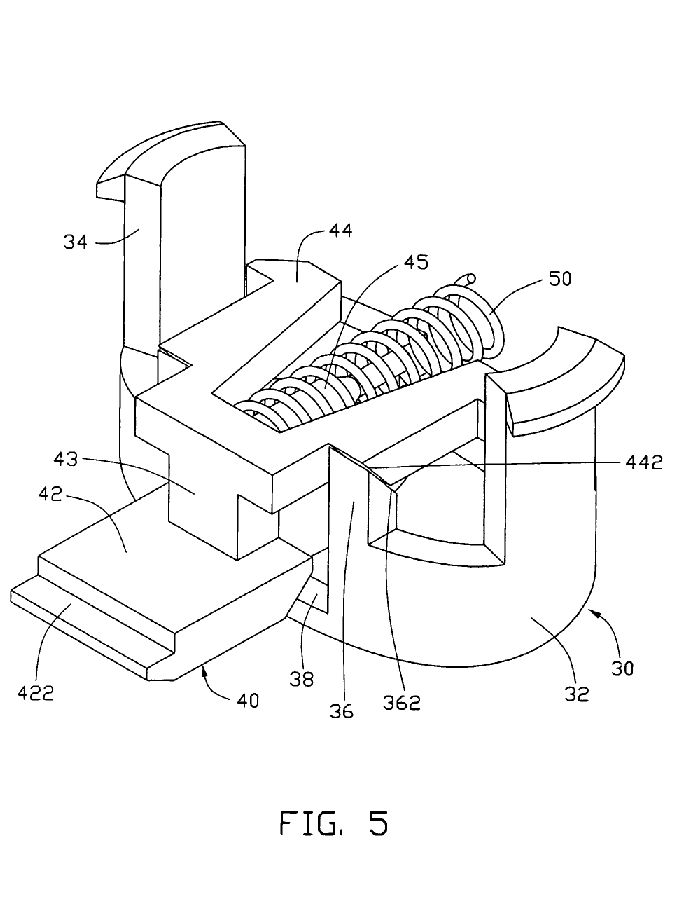

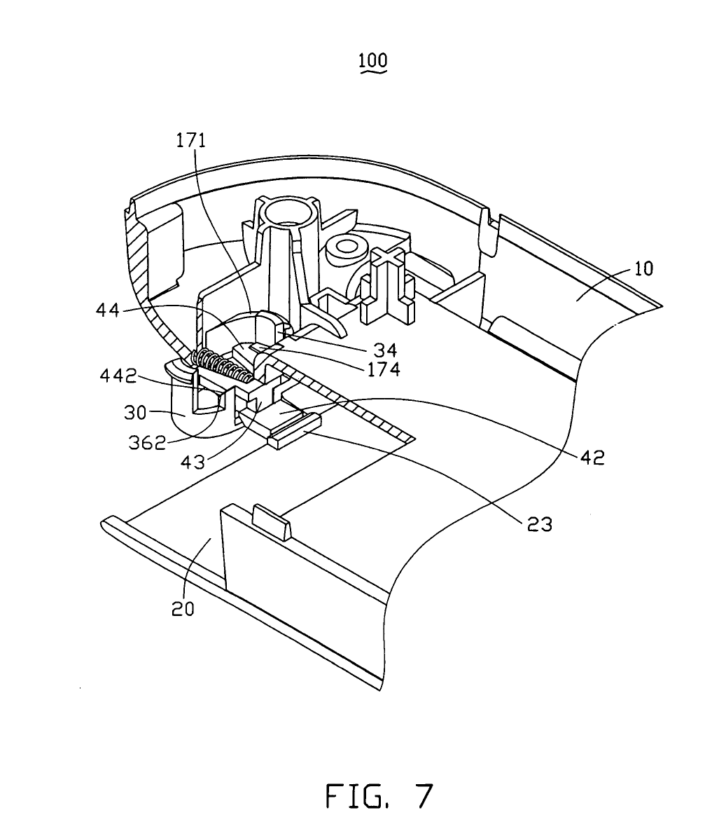

Also referring to FIG. 4, the latching member 40 includes a bolt portion 42, a connecting portion 43, and two elastic positioning portions 44. The bolt or locking portion 42 and the positioning portions 44 are parallel and offset to each other. The connecting portion 43 connects the bolt portion 42 and the positioning portions 44 together. The bolt portion 42 is substantially a rectangular board. A protrusion 422 extends from one end of the bolt portion 42, which is opposite to an end thereof adjoining the connecting portion 43. The protrusion 422 is configured for releasable engagement with the locking hole 24 of the battery cover 20, thereby allowing the bolt portion 42 to lock or bolt the latching member 40 to the battery cover 20. The protrusion 422 has a beveled outer surface to facilitate the entry/exit thereof with respect to the locking hole 24. Each of the positioning portions 44 has a protruding block 442 at a side thereof facing away from the other positioning portion 44. Each protruding block 442 has an inclined surface with this inclined surface generally facing toward the bolt portion 42. Referring also to FIG. 5, the inclined surface of each protruding block 442 is configured for slidingly engaging with a corresponding inclined surface 362. Specifically, the protruding block 442 and the corresponding inclined surface 362 are to operably mate in such a fashion that a movement of the board 33 (i.e., during operation of the button 30) toward the positioning portion 44 will ultimately result in the movement of the protrusion 422 toward the button 30. The positioning portions 44 each have a tab 446 at a distal end thereof, each tab 446 being directed away from the opposite positioning portion 44. As such, each tab 446 is configured for releasably abutting a corresponding positioning tab 174 (as best seen in FIG. 7) and, thereby, acting to limit the potential travel of the latching member 40. A pole portion 45 is formed at the connecting portion 43, protruding substantially orthogonally thereto and in the same general direction as the positioning portions 44.

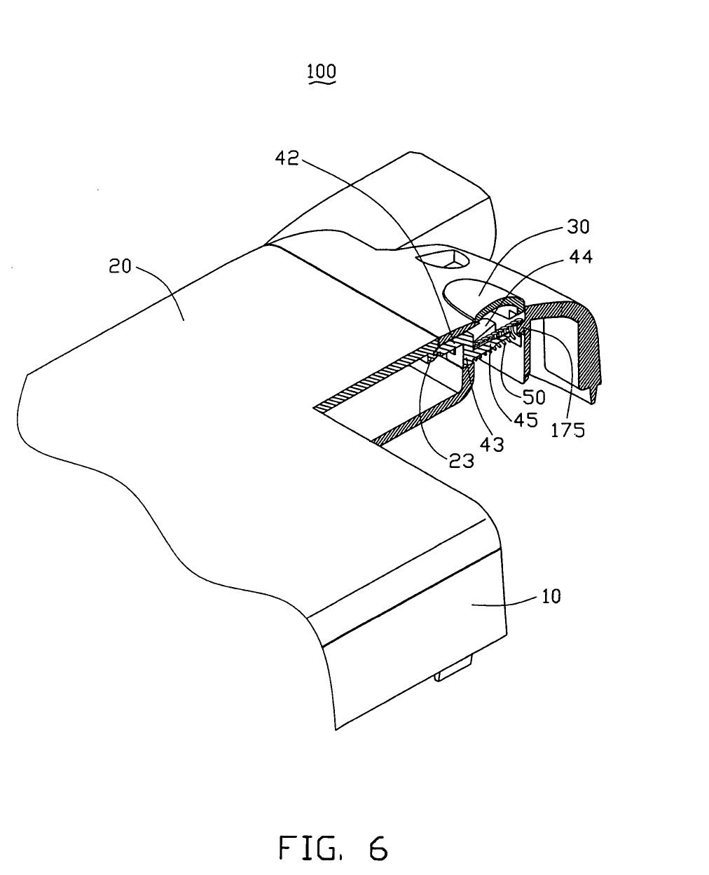

In assembly, one end of the spring 50 is located around the positioning pin 175 of the housing 10. The latching member 40 is inserted into the button hole 172. The positioning portions 44 travel through the third receiving hole 154. During this process, the pole portion 45 is gradually inserted into the spring 50, and the distal ends of the tabs 446 of the positioning portions 44 respectively slide along the two corresponding sides of the positioning tabs 174 and are compressed against the positioning tabs 174. When the tabs 446 travel over the distal ends of the positioning tabs 174, the tabs 446 decompress and thereby abut such distal ends. The protrusion 422 of the bolt portion 42 of the latching member 40 extends out an edge of the top backboard 17 (FIG. 6).

Further, the button 30 is inserted into the button hole 172. The arcuate blocks 342 of the arms 34 are inserted through compressed by the projection 171, with the aid of the beveled surface of such blocks 342. When the arcuate blocks 342 travel against the projection 171 during the insertion step, the arms 34 deflect inwardly toward the interior of the barrel body 32 (i.e., into the button hole 172). However, once the arcuate blocks 342 travel beyond the projection 171, the arms 34 spring outward, and the arcuate blocks 342 abut the distal edge of the projection 171 in the rest position of the button 30. As such, arms 34 and, particularly, arcuate blocks 342 establish a travel limit of the button 30 (i.e., the button 30 cannot be readily dislodged through the projection 171) yet allow for the depression of the button 30 (i.e., can move blocks 342 and projection 171 out of contact with each other). The inclined surface of the protruding block 442 of the latching member 40 is engaged with the inclined surface 362 of the button 30. Thus, the battery cover latching assembly 80 is assembled in the housing 10.

When the battery cover 20 is assembled to the housing 10, the hooks 22 of the battery cover 20 are received in the grooves 162 of the housing 10. Pressing the opposite end of the battery cover 20 down to the housing 10, the beveled outer surface of the protrusion 422 is pressed into contact with the locking block 23. Then, the latching member 40 moves in toward the button hole 172, and the spring 50 is compressed. When the protrusion 422 moves into the locking block 23, the spring 50 decompresses and moves the protrusion 422 of the latching member 40 out of the first receiving hole 152. Hence, the protrusion 422 is received in the locking hole 24 of the battery cover 20. Thus, the battery cover 20 is assembled with the housing 10, as represented in FIGS. 6 and 7.

When the battery cover 20 is to be detached from the housing 10, the button 30 is pressed. Each post 36 of the button 30, via the inclined surface 362, presses against the corresponding protruding block 442 of the latching member 40, and the latching member 40 moves inward toward the button hole 172. At the same time, the spring 50 is compressed. The protrusion 422 of the latching member 40 correspondingly moves out of engagement with the locking hole 24 of the battery cover 20, thus releasing the battery cover 20. The battery cover 20 is pulled away from the housing 10 by means of a user putting his/her finger in the U-shaped groove 134 of the housing 10. Release the button 30, the spring 50 is decompressed and moves the protrusion 422 of the latching member 40 to extend outward of the first receiving hole 152.

As described above, the preferred embodiment provides a battery cover latching assembly for portable electronic devices, such as mobile phones. When the button is pushed, the cover of the battery cover assembly can be easily removed. This button-activated latching assembly provides the user with convenient operation of the device. It is further to be understood that such a button-activated latching assembly could prove useful in allowing releasable attachment of covers or doors of other devices, and such uses are considered to be within the scope of the present latching assembly.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device having a battery cover, a housing, and a battery cover latching assembly, the battery cover latching assembly comprising:
a locking hole defined in the battery cover;
a button having a first inclined portion;
a latching member comprising a bolt portion and a positioning portion, one end of the bolt portion being received in the locking hole, the positioning portion having a second inclined portion; and
a button hole defined in the housing, the button hole receiving the positioning portion and the button, with the second inclined portion engaging with the first inclined portion.

2. The portable electronic device as claimed in claim 1, further comprising a spring, wherein one end of the spring is resisted by the housing, and an opposite end of the spring is resisted by the positioning portion.

3. The portable electronic device as claimed in claim 2, wherein the latching member includes a pole portion, the pole portion extends from the positioning portion, and the opposite end of the spring surrounds the pole portion.

4. The portable electronic device as claimed in claim 2, wherein the housing includes a pin, and the one end of the spring surrounds the pin.

5. The portable electronic device as claimed in claim 1, wherein the button includes a barrel body, a post extends from one end of the barrel body, and the first inclined portion is disposed at a distal end of the post.

6. The portable electronic device as claimed in claim 5, wherein the positioning portion includes a protruding block, and the second inclined portion is disposed at a distal end of the protruding block.

7. The portable electronic device as claimed in claim 1, wherein the latching member further includes a connecting portion, and the connecting portion adjoins the bolt portion and positioning portion together.

8. The portable electronic device as claimed in claim 1, wherein the housing includes a projection, and the button hole is defined in the projection.

9. The portable electronic device as claimed in claim 8, wherein the button includes an arm configured for abutting with one end of the projection and for thereby limiting movement of the button.

10. The portable electronic device as claimed in claim 8, wherein the projection has a receiving hole defined therein, and the bolt portion protrudes out from the receiving hole.

11. The portable electronic device as claimed in claim 1, wherein the battery cover further defines a hook at one end thereof.

12. The portable electronic device as claimed in claim 11, wherein the housing further defines a groove configured for receiving the hook of the battery cover.

13. An assembled device including a first member, a second member, and a first member latching assembly, the first member latching assembly comprising:
a locking hole defined in the first member;
a button having a first inclined portion;
a latching member comprising a bolt portion and a positioning portion, one end of the bolt portion being received in the locking hole, the positioning portion having a second inclined portion; and
a button hole defined in the second member, the button hole receiving the positioning portion and the button, with the second inclined portion engaging with the first inclined portion.
